(19) United States
(12) Patent Application Publication
(10) Pub. No.: US 2012/0132088 A1
(43) Pub. Date: May 31, 2012

(54) MACHINE FOR BINDING REINFORCEMENT BARS

(75) Inventors: Graham Frank Barnes, Surrey (GB); Ian David Coles, West Sussex (GB)

(73) Assignee: TYMATIC LIMITED, Mayfield, East Sussex (GB)

(21) Appl. No.: 13/320,242

(22) PCT Filed: May 11, 2010
(86) PCT No.: PCT/GB10/00934

§ 371 Date: Jan. 23, 2012

(30) Foreign Application Priority Data
May 11, 2009 (GB) 0908105.0

(51) Int. Cl. B30B 9/30

(52) U.S. Cl. 100/8

(57) ABSTRACT

An apparatus for tying a wire around one or more objects such as concrete reinforcing bars is disclosed. It comprises means for passing the wire in a loop around the bars and a rotatable head for twisting the ends of the loop together. The head has at least one clamping member for clamping the wire. The clamping member provides a higher clamping force when tension in the wire is increases.

### BACKGROUND OF THE INVENTION

1. Field of the Invention

This application relates to machines for binding together concrete reinforcing bars using wire ties.

One such machine is described in WO 2004/083559.

2. Description of the Related Art

A problem with known machines has been identified by the Applicant. To achieve the proper tension in the twisted wire known machines rely on the bending strength of the wire and friction exhibited between the wire and the gripping parts of the machine. However, if the surface of the wire or the interior gripping surface inside the machine should be contaminated with oil or grease, or indeed even if the machine is used in damp conditions, the degree of friction actually exhibited may be less than intended leading to a lower tension in the twisted wire and therefore a more loosely tied connection.

### SUMMARY OF THE INVENTION

The present application aims to reduce this problem and provides a machine for tying a wire around a pair of bars comprising means for passing said wire in a loop around the bars and a twisting head for twisting the ends of said loop together, said twisting head comprising at least one pivoting clamping member for clamping the end of the wire against a clamping surface, said clamping member having a curved surface which applies a clamping force to the wire which increases as the tension in the wire increases.

Thus the machine of the invention increases the amount of grip applied to the ends of the wire as tension increases in the wire during twisting. This helps to overcome the problems encountered in use of prior art devices in which the amount of grip could be influenced by uncontrolled external factors. The clamping surface is preferably part of the twisting head or is fixed relative to the twisting head.

Preferably the twisting head comprises two clamping members, one for each end of the wire.

Preferably the clamping member is at an initial angle to the normal of the wire of between 5 degrees and 20 degrees. In some embodiments the angle is between 6 degrees and 8 degrees. This provides a clamping force sufficient to prevent slipping of the wire up to a wire tension of between 350 and 400 Newtons, which is a typical tensile failure force for wires typically used for tying reinforcement bars. In other embodiments the angle is between 12 degrees and 15 degrees. This provides a maximum clamping force corresponding to a tension in the wire of less than 350-400 N and so allows the wire to slip during the tying procedure.

Where the clamping member or members applies a clamping force that prevents slipping, preferably the twisting head is resiliently mounted so as to be drawn towards the bars against a resilient bias force during twisting. This has the effect of limiting the tension in the wire so that it is less prone to breaking under excess tension. Preferably said resilient mounting is provided by a sprung housing, stand or frame which engages the object(s) being tied. Alternatively, the compressible portion of the machine may be provided elsewhere, e.g. between a frame or housing and the parts of the machine mounting the twisting head.

Preferably the clamping member moves through an angle about its pivot axis of between 0.25 and 2 degrees during twisting, preferably in the direction of reducing the initial angle. Where the angle to the normal is between 6 and 8 degrees, preferably the clamping member is arranged to pivot through between 1 and 2 degrees. Where the angle to the normal is between 12 and 15 degrees, preferably the clamping member is arranged to pivot through between 0.5 and 1 degree.

Preferably the maximum clamping force is between 2000 and 6000 Newtons. In some embodiments it is greater than 2500 Newtons. In other embodiments it is greater than 5000 Newtons.

In some embodiments the machine is adapted to detect when an end of the wire has been pulled out from the clamping member. Preferably the machine is adapted to stop the motor rotating the twisting head when an end of the wire has been pulled out from the clamping member.

In other embodiments the machine is adapted to release the clamping member or members when a tie has been completed. This could be by measuring a total tying time, or detecting a maximum allowed tying torque.

### BRIEF DESCRIPTION OF THE DRAWINGS

Certain preferred embodiments of the invention will now be described, by way of example only, with reference to the accompanying drawings in which:

FIG. 1a is a perspective view of an apparatus embodying the invention above a pair of crossed bars prior to a tying operation being initiated;

FIG. 1b is a view similar to FIG. 1a with the main mounting bracket removed;

FIG. 2 sectional view through the apparatus shown in FIG. 1;

FIG. 3 is a view of the apparatus from beneath;

FIG. 4 is a sectional view similar to FIG. 2 showing the apparatus part-way through a tying operation;

FIG. 5a is another sectional view showing the wire tensioned prior to twisting;

FIG. 5b is an enlargement of the circled part of FIG. 5a.

### DETAILED DESCRIPTION OF THE PREFERRED EMBODIMENT

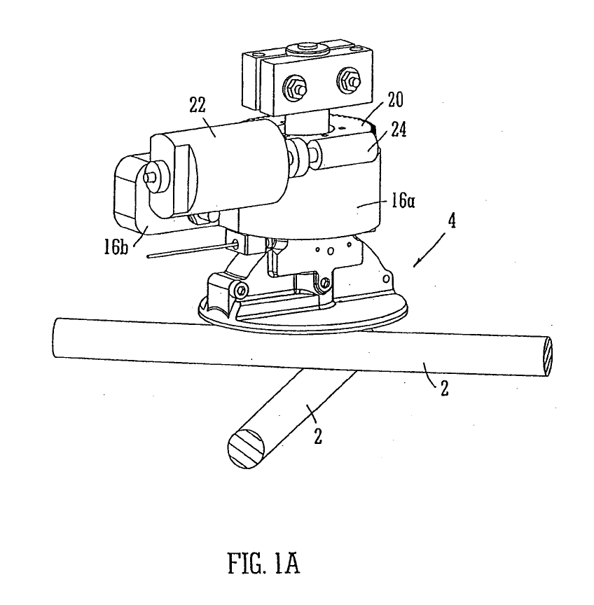

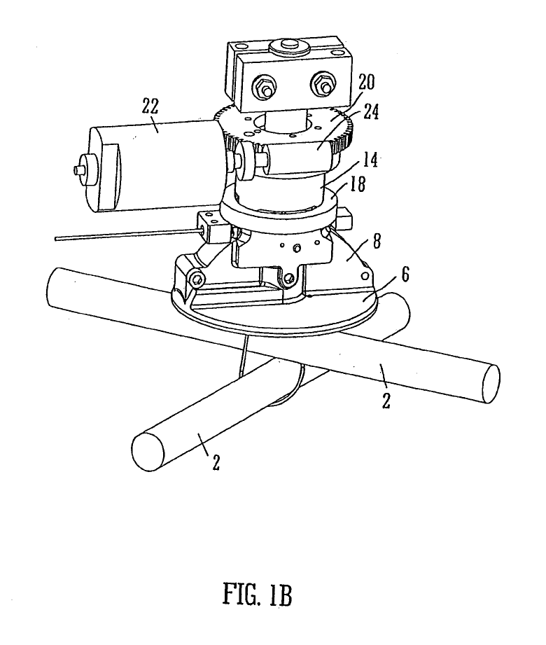

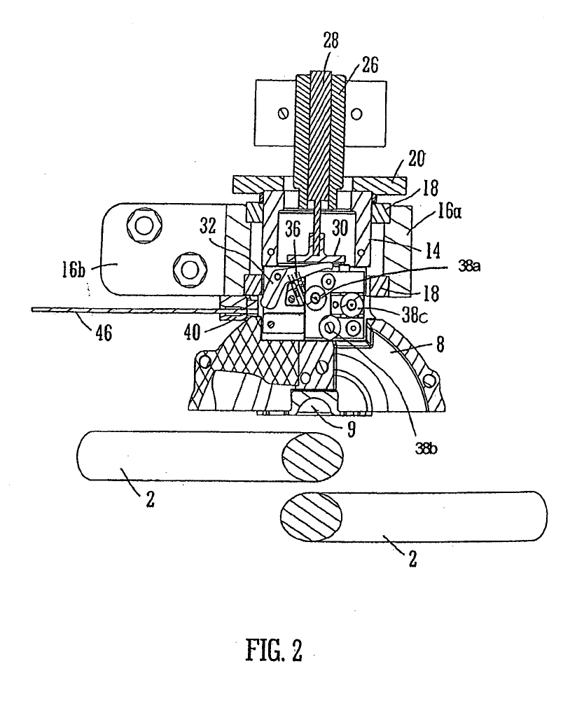

Referring first to FIGS. 1a, 1b and 2 there are shown two perspective views and a sectional view of part of an apparatus in accordance with the invention with certain parts such as the housing, handle, battery, controls, lower shroud and wire spool removed for clarity. The apparatus is shown situated over a junction where two steel bars 2 cross over each other at right angles. The steel bars 2 are intended to form a rectangular grid to be embedded in a concrete structure in order to reinforce it.

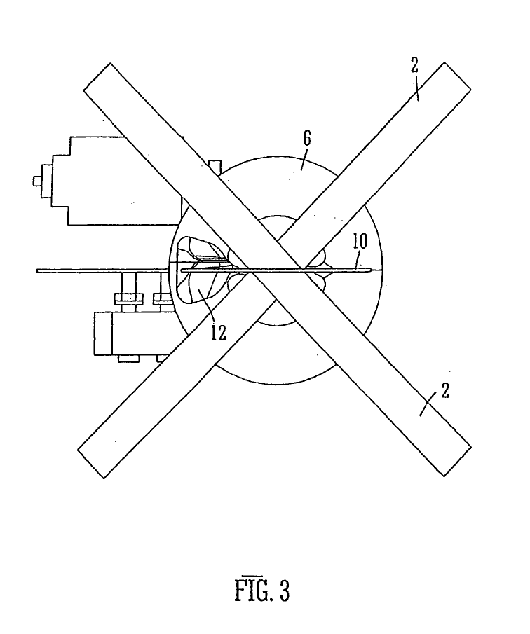

Sitting in use above the uppermost bar 2 is the rotary head of the apparatus 4. This includes a horizontal circular base plate 6 extending up from which is a channel 8 which is approximately semi-circular in vertical section and of approximately constant width in the orthogonal direction. The underneath of the base plate 6 is shown in FIG. 3 from which it will be seen that on one side there is a narrow slot 10 corresponding to one end of the semi-circular channel and on the other side of the plate 6 corresponding to the other end of the channel is a funnel region 12.

Returning to FIGS. 1a, 1b and 2, attached to the semi-circular channel 8 is the upper cylindrical portion of the head 14 which is rotatably mounted in the cylindrical portion 16a of a bracket member mounted to the housing (not shown) by a flange portion 16b (omitted from FIG. 1b). The upper head portion is supported by two rotary bearings 18. A toothed gear wheel, 20 is provided fixed at the top of the head to allow it to be driven by a motor 22 via a worm gear.

Extending through the gear wheel 20 into the open upper end of the head 4 is a solenoid assembly comprising a cylindrical outer tube 26 housing the coil and an inner plunger 28 which is able to slide vertically relative to the coil 26. At the bottom end of the plunger 28 is an actuating disc 30, the purpose of which will be explained later.

The internal construction of the head 4 will now be described. On the left hand side as seen from FIG. 2, there may be seen a pivotally mounted angled clamping member 32. The member comprises a longer, upper arm and a shorter, lower arm. A pair of compression springs 36 act on the upper arm so as to bias the member in an anti-clockwise direction in which the lower arm is held in contact with the wire. Of course any number of springs might be used or the springs could be omitted.

The Figures show the clamping members 32 only schematically, and so do not allow a deduction to be made as to angles. However in one example the angle between the central axis of the lower arm of the clamping member 32 and the normal to the wire (i.e. the direction perpendicular to the length of the wire) is between 12 and 15 degrees.

To the right of the clamping member 32 are a series of roller wheels 38a, 38b, 38c the purpose of which will be explained below. A second clamping member is provided displaced approximately 180 degrees around the head. This is not therefore visible in the sectional view.

To the left of the upper head portion 14, connected to the main bracket flange portion 16b, is a wire feed inlet guide 40 which receives the free end of wire 46 which has been unwound from the spool (not shown).

Operation of the apparatus will now be described. The apparatus is first placed above the uppermost of a pair of steel reinforcing bars 2 which are crossed at right angles. The operator may then commence the tying operation. The first part of this operation is to energise the solenoid coil 26 which pushes the plunger member 28 downwardly. This causes the actuating member 30 at the end of the plunger to be pressed downwardly onto the upper arms of the clamping members 32 to press them down against the respective compression springs 36 and therefore raise the shorter, lower arms. This is the position which is shown in FIG. 2.

A motor (not shown) is operated to drive a wire feed roller (also not shown) that acts on the wire 46 to feed it from the spool through the wire inlet guide 40 and into the aligned channel in the upper head portion 14. The wire is fed in horizontally past the end 32a of the first clamping member 32 which is held away from the wire by the actuating disc 30 acting on the long arm of the clamping member. The wire encounters the first of the passive rollers 38a. The first roller 38a causes the wire to bend downwardly slightly so that it passes between the second and third rollers 38b, 38c. The relative positions of the three passive rollers 38a,38b,38c is such that when the wire 46 emerges from them it is bent so as to have an arcuate set. As the wire 46 continues to be driven by the wire feed roller, it encounters and is guided by the inner surface of the semi-circular channel 8.

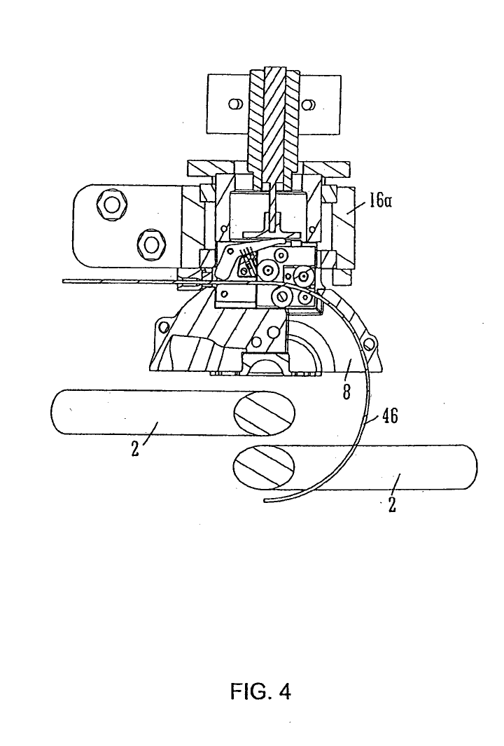

When the wire 46 emerges from the channel 8, its arcuate set causes it to continue to describe an approximately circular arc, now unguided in free space, around the two reinforcing bars. This is shown in FIG. 4. As the wire 46 continues to be driven, the free end will eventually strike the mouth of the funnel region 12 in the bottom of the base plate 6 and therefore be guided back into the semi-circular channel 8. However it is not guided back precisely diametrically opposite where it was issued from but rather slightly laterally offset therefrom. This allows the second clamping member (not shown) to be located next to the first clamping member 32 which enables the apparatus to be kept relatively compact.

As the free end of the wire re-enters the semi-circular channel 8, it passes beneath the second clamping member, also held away from the wire end by the actuating disc 30 acting on the long arm of the clamping member.

Once the free end of the wire 46 is detected by a suitable detector, the motor feeding the wire is stopped and therefore the wire does not advance any further. At this point the solenoid coil 26 is then de-energised which causes the plunger 28 to be retracted by a spring (not shown) which releases the two clamping members 32 so that the respective compression springs 36 act to return the respective ends 32a into contact with the two ends of the wire loop and therefore hold the wire 46 in place.

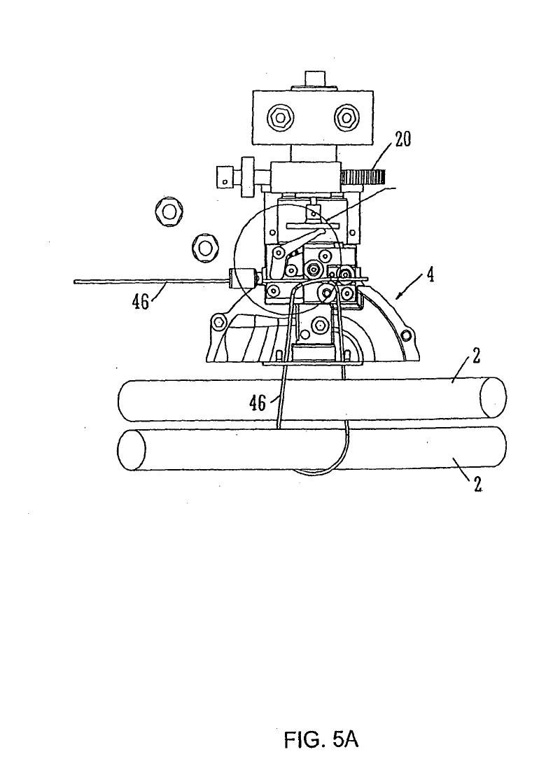

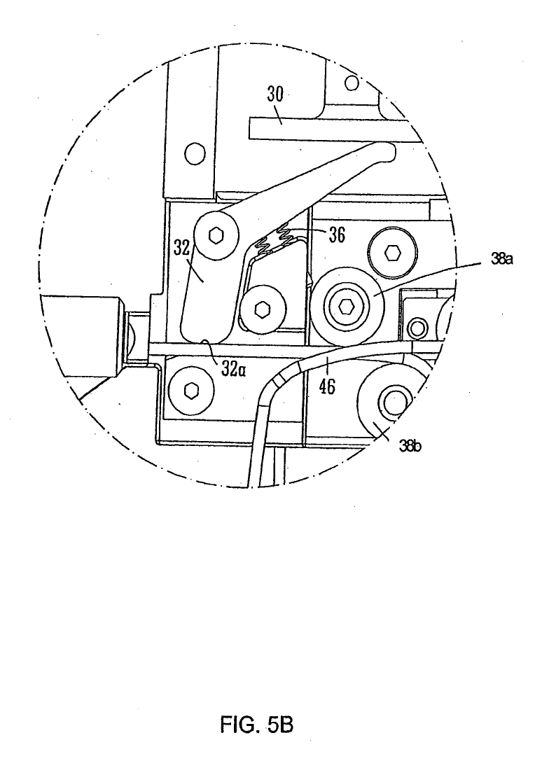

The wire feed motor is driven in reverse in order to apply tension to the wire loop which draws the wire in around the reinforcing bars 2. This may be seen in FIG. 5a. FIG. 5b shows detail of the clamping member 32 on the feed side clamping the end of the wire 46. A similar arrangement clamps the other end of the wire as explained above. As the tension in the wire increases, the ends of the clamping members 32a roll over the wire slightly. The curvature of these ends of the clamping members 32a causes them to increase the clamping force as the tension in the wire increases to firmly clamp the ends. When the wire 46 is fully tensioned it will be seen from FIG. 5a that the two ends of the loop are pulled up almost vertically from their initial circular profile. As the head 4 tries to start rotating at the beginning of the twisting operation the torque supplied by the motor 22 is sufficient to shear the wire at the point where it crosses from the inlet guide 40 to the upper head portion 14 without the need for it to be cut. With the wire thus broken, the head 4 begins to twist the sides of the loop together above the reinforcing bars 2.

As the twisting proceeds, the tension in the wire 46 continues to increase. The shape of the rounded ends 32a of the clamping members causes them to roll over the end of the wire and bite down harder on the wire to increase the clamping force on the wire so that a very tight tie can be formed. For example the clamping member might pivot between 0.5 and 1 degree as the tension increases. The maximum clamping force applied is for example between 2000 and 3000 Newtons. When the tension in the wire reaches a maximum value, e.g. in the range 250-350 Newtons, the maximum clamping force applied by the clamping members can no longer hold the ends of the wire and the wire then slips past the clamping members 32 until it is released. The continued twisting of the head 4 causes the ends of the wire to be neatly wrapped at a low tension as the ends of the wire are pulled completely out of the head. This reduces the risk of sharp ends being left protruding which would be a snagging hazard.

The machine can sense when the ends of the wire have come out as there will be a sudden reduction on the torque on the motor driving the twisting head. This can be sensed by a corresponding reduction in the electrical current drawn by the motor. The motor can be stopped when this is sensed or a short time thereafter to allow final twisting of the emerging ends of the wire.

In another embodiment the initial angle of the lower arm of the clamping member to the wire's normal is between 6 and 8 degrees. In this case the clamping member pivots as the tension increases to reduce the angle by between 1 and 2 degrees. This gives rise to a maximum clamping force approximately twice that of the previous embodiment—i.e. between approximately 4000 and 6000 Newtons. This corresponds to a maximum tension in the wire greater than its failure tension which is typically between 350 and 400 Newtons. Therefore to avoid breaking the wire the clamping members are automatically released by operating the solenoid 26 to press down on the actuating disc 30 and release the clamping members 32 from the wire 46, allowing it to be drawn out completely from the head as in the previous embodiment.

Also to avoid breaking the wire, the twisting head is resiliently mounted relative to the bars so that it can be drawn towards them as the tie is formed.

What is claimed is:

1. A machine for tying a wire around a pair of bars comprising means for passing said wire in a loop around the bars and a twisting head for twisting the ends of said loop together, said twisting head comprising at least one pivoting clamping member for clamping the end of the wire against a clamping surface, said clamping member having a curved surface which applies a clamping force to the wire which increases as the tension in the wire increases.

2. A machine as claimed in claim 1 wherein the twisting head comprises two clamping members, one for each end of the wire.

3. A machine as claimed in claim 1 wherein the clamping member is at an initial angle to the normal of the wire of between 5 degrees and 20 degrees.

4. A machine as claimed in claim 3 wherein said initial angle is between 6 degrees and 8 degrees.

5. A machine as claimed in claim 3 wherein said initial angle is between 12 degrees and 15 degrees.

6. A machine as claimed in claim 1 wherein the clamping member can pivot about its pivot axis through an angle of between 0.25 and 2 degrees during twisting.

7. A machine as claimed in claim 4 wherein the clamping member can pivot about its pivot axis through an angle of between 1 and 2 degrees during twisting.

8. A machine as claimed in claim 5 wherein the clamping member can pivot about its pivot axis through an angle of between 0.5 and 1 degree during twisting.

9. A machine as claimed in any preceding claim 1 wherein the clamping member applies a clamping force that prevents slipping of the wire and wherein said twisting head is resiliently mounted so as to be drawn towards the bars during twisting.

10. A machine as claimed in claim 9 wherein said resilient mounting is provided by a sprung housing, stand or frame which engages said bars; or by a compressible portion of the machine.

11. A machine as claimed in claim 1 wherein the maximum clamping force applied by the clamping member is between 2000 and 6000 Newtons.

12. A machine as claimed in any preceding claim 1 wherein the clamping member can apply a clamping force until the tension in the wire is between 250 and 350 Newtons.

13. A machine as claimed in claim 1 which is adapted to detect when an end of the wire has been pulled out from the clamping member.

14. A machine as claimed in claim 13 which is adapted to stop the motor rotating the twisting head when an end of the wire has been pulled out from the clamping member.

15. A machine as claimed in claim 1 wherein the clamping surface is part of the twisting head or is fixed relative to the twisting head.
